(19) United States
(12) Patent Application Publication
(10) Pub. No.: US 2008/0164681 A1
(43) Pub. Date: Jul. 10, 2008

(54) Apparatus and Methods for Passive Restraint

(75) Inventor: Rao N. Nuthalapati, Rochester Hills, MI (US)

Correspondence Address: KAPLAN GILMAN GIBSON & DERNIER L.L.P., 900 ROUTE 9 NORTH, WOODBRIDGE, NJ, 07095, US

(73) Assignee: FAURECIA INTERIOR SYSTEMS U.S.A., INC., Auburn Hills, MI (US)

(21) Appl. No.: 11/620,854

(22) Filed: Jan. 8, 2007

(51) Int. Cl. B60R 21/16

(52) U.S. Cl. 280/734

(57) ABSTRACT

A passive restraint system for a vehicle is disclosed that may include a bolster having a first surface fixed with respect to a structural component of the vehicle and a second surface forming a portion of interior trim of the vehicle; and an inflator for expanding the bolster and moving the inner surface of the bolster toward a passenger compartment of the vehicle, upon activation of the passive restraint system.

### BACKGROUND OF THE INVENTION

The present invention relates in general to vehicle safety systems and in particular to a passive restraint system including an inflatable device.

Passive restraint systems are commonly accepted as beneficially supplementing the passenger protection afforded by active restraint systems, such as lap and shoulder seat belts. One common form of passive restraint system includes one or more air bags.

Inflatable airbags enjoy widespread acceptance as passive passenger restraints for use in motor vehicles. This acceptance has come as airbags have built a reputation of preventing death and injury over years of use. Studies show that in some instances, the use of certain vehicular airbags can reduce the number of fatalities in head-on collisions by 25% among drivers using seat belts and by more than 30% among unbelted drivers. Other statistics suggest that in a frontal collision, the combination of a seat belt and an airbag can reduce the incidence of serious chest injuries by 65% and the incidence of serious head injuries by up to 75%. Therefore, air bags represent a significant advance in the art of vehicle safety.

Airbags are generally linked to a control system within the vehicle that triggers their activation when a collision occurs. Generally, an accelerometer within the vehicle measures the abnormal deceleration caused by the collision event and triggers the ignition of an airbag inflator. This control system is often referred to as an electronic control unit (or “ECU”). The ECU includes a sensor that continuously monitors the acceleration and deceleration of the vehicle and sends this information to a processor that uses an algorithm to determine whether a deceleration experienced by the vehicle is caused by a collision or accident. Additional sensors may be linked to the ECU to allow the proper detection of side-impact collisions, rollovers, and so forth.

Air bags are generally made of fabric, such as canvas and are generally expanded at very high pressures to generate sufficient force to prevent collision of a vehicle occupant with hard interior vehicle surfaces. The requirement of such high pressures may impair the ability to coordinate the relative timing of the deployment of plural airbags and to fine the tune the force of the impact of the air bag upon the vehicle occupant. Thus, there is a need in the art for an increased ability to fine tune the deployment of vehicle passive restraint systems.

Moreover, the bags of airbag systems are generally discarded after a single use. This feature tends the remove the ability to test the operation of individual airbag systems, thereby causing their deployment during a collision to be the only instance in which that particular air bag will ever be used. Accordingly, there is a need in the art for improved passive restraint systems.

### SUMMARY OF THE INVENTION

In accordance with one aspect, the invention is direct to a passive restraint system for a vehicle that may include a bolster having a first surface fixed with respect to a structural component of the vehicle and a second surface forming a portion of interior trim of the vehicle; and an inflator for expanding the bolster and moving the inner surface of the bolster toward a passenger compartment of the vehicle, upon activation of the passive restraint system.

According to another aspect, the invention is directed to a method for providing passive restraint in a vehicle, that may include providing a bolster having a first surface fixed with respect to a structural component of the vehicle and a second surface forming a portion of interior trim of the vehicle; activating the passive restraint system; and expanding the bolster to thereby move the inner surface of the bolster toward a passenger compartment of the vehicle.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a partially sectional and partially elevational side view of a vehicle door including a passive restraint system in accordance with one or more embodiments of the present invention;

FIG. 2 is a perspective view of the passive restraint system of FIG. 1, in accordance with one or more embodiments of the present invention;

FIG. 3 is a another perspective view of the passive restraint system of FIG. 1, in accordance with one or more embodiments of the present invention; and

FIG. 4 is an elevational view of the bolster of FIG. 1 extending into a passenger compartment of the vehicle interior, in accordance with one or more embodiments of the present invention.

### DETAILED DESCRIPTION OF THE PREFERRED EMBODIMENTS

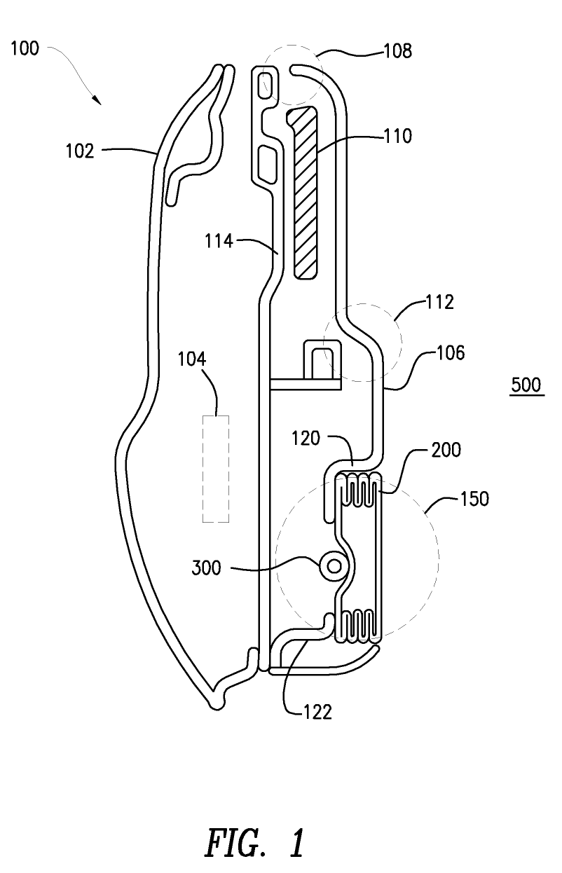

FIG. 1 is a partially sectional and partially elevational side view of a vehicle door 100 that may include a bolster 200 and/or an inflator 300 in accordance with one or more embodiments of the present invention. In one or more embodiments, vehicle door 100 may include passive restraint system 150, which may in turn include bolster 200 and inflator 300. Vehicle door 100 may further include outer door 102, door beam 104, door trim 106, beltline area 108, shoulder foam 110, arm rest area 112, inner door (or “module”) 114, upper bracket 120, and/or lower bracket 122. FIG. 1 also shows vehicle interior 500.

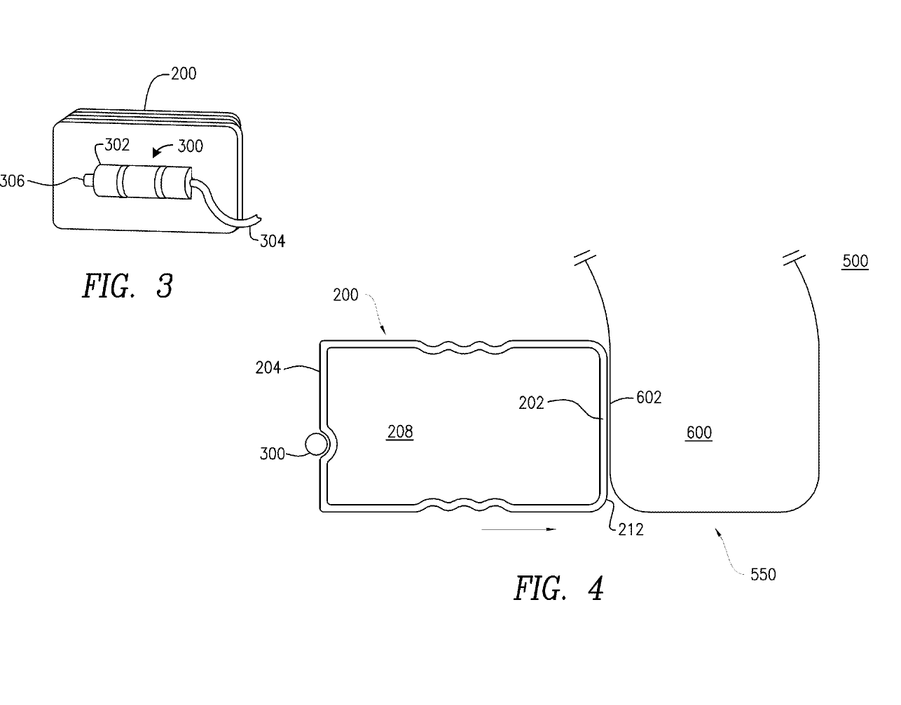

With reference to FIG. 3, inflator 300 may include gas canister 302, squib wires 304, and/or inflator nozzle 306. In the event of a collision, suitably configured control circuitry may enable the transfer of pressurized gas from gas canister 302 to bolster 200. In one or more alternative embodiments, inflator 300 may include a pyrotechnic disposed within an interior of bolster 200.

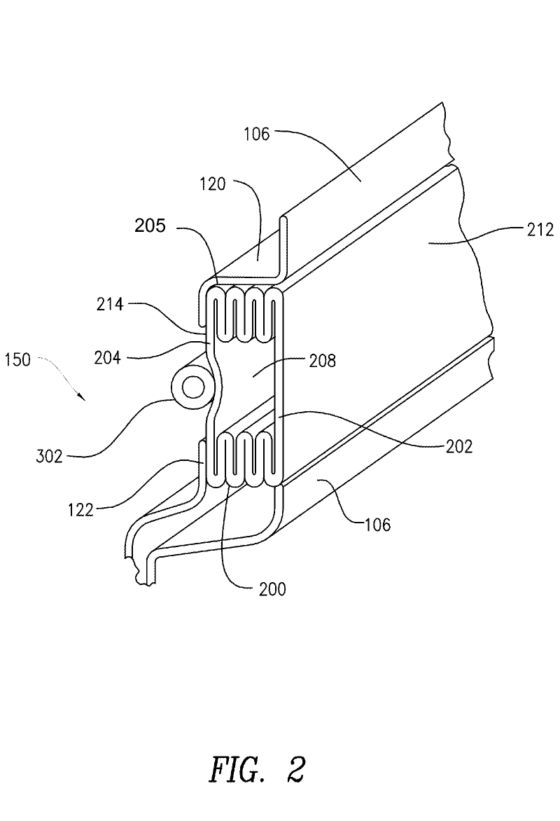

With reference to FIGS. 2 and 4, passive restraint system 150 may be operable to expand bolster 200 toward a passenger compartment 550 (FIG. 4) of vehicle interior 500 in the event of a vehicle collision, to protect a vehicle occupant 600 in passenger compartment 550 against impact with portions of vehicle door 100 or other surfaces within the vehicle interior that may cause injury to the occupant. Passive restraint system 150 may be operable to provide greater protection than existing passive restraint systems by providing a bolster of sturdier construction than existing air bags, which may enable using lower inflation pressures for expanding bolster 200. Moreover, passive restraint system 150 may enable more accurate tuning of the impact force of bolster 200 with a vehicle occupant and/or more accurate adjustment of the timing of the expansion of bolster 200 into the passenger compartment 550 in relation to the point in time at which a vehicle collision occurs and/or in relation to a point in time the of an activation of one or more other restraint systems.

The structural and operational aspects of passive restraint system 150 may be implemented in any region of the vehicle that includes vehicle door 100 where a danger of occupant impact with a vehicle surface exists. Passive restraint system 150 may achieve superior performance when configured such that bolster 200 expands towards and/or makes contact with a pelvic portion and/or a thoracic portion of a vehicle occupant 600 in passenger compartment 550, in the event of a triggering event causing activation of passive restraint system 150. However, the present invention is not limited to being deployed in the two regions identified above. For the sake of convenience, passive restraint system 150 is shown deployed in the pelvic region in FIGS. 1 and 4.

The bolster 200 of passive restraint system 150 is now discussed in greater detail in connection with FIG. 2. FIG. 2 is a perspective view of the passive restraint system 150 of FIG. 1, in accordance with one or more embodiments of the present invention. Passive restraint system may include bolster 200 and/or inflator 300. The bolster 200 may include an inner layer 202, having an inner surface 212 that faces the interior 500 of the vehicle, and an outer layer 204 having an outer surface 214 that may be fixed with respect to one or more structural components of the vehicle, such as brackets 120 and 122. Bolster 200 may further include interior or cavity 208 and a folded material portion 204 which may form an accordion shape when bolster 200 is in a compressed state.

The bolster 200 may be restorable to its compressed condition after being deployed (and expanded) as a result of a vehicle collision. Moreover, bolster 200 may be reusable after being so restored. The restorability and/or reusability of bolster 200 may be enabled by one or more of the following aspects: the nature of the integration of bolster 200 into the remainder of vehicle door 100; one or more materials included in bolster 200; and/or the dimensions of the bolster 200. The above is not intended to limit the number the aspects of bolster 200 that may enable reusability thereof in accordance with one or more embodiments of the present invention. Other aspects of bolster 200 may contribute to such reusability either alone, or in combination with one or more of the above-listed factors.

In one or more embodiments, bolster 200 may be integrated into vehicle door 100 by having the inner surface 212 of inner layer 202 of bolster 200 form a portion of the interior trim 106 of vehicle door 100. In such embodiments, the inner surface 212 of bolster 200 may include a material composition and/or one or more dimensions such as thickness that are at least substantially similar to, or the same as, those of door trim 106. Moreover, inner surface 212 of bolster 200 may be lined up with door trim 106 along an axis normal to the plane of door trim 106. With this arrangement, the inner surface 212 of bolster 200 may be situated so as to neither protrude from, nor recede from, a remainder of the surface of door trim 106. Otherwise stated, inner surface 212 of bolster 200 may be flush with the surface of door trim 106.

With this arrangement, a deployment of passive restraint system 150 need not require a portion of door trim 106 to be dislodged and/or discarded for bolster 200 to properly expand into passenger compartment 550 (FIG. 4). Moreover, the door-trim material of the inner surface 212 may provide the additional benefit of serving as a cushion for an impact with vehicle occupant 600 upon the expansion of bolster 200 into passenger compartment 550. Thus, in one or more embodiments having the features described above, after having been expanded because of an activation of passive restraint system 150, bolster 200 may be forced back into a compressed (i.e. pre-collision) condition, thereby restoring continuity and completeness to the surface of door trim 106.

In one or more alternative embodiments of the invention, bolster 200 inner surface 212 may include material other than the material used for a remainder of door trim 106 and/or may be situated closer to, or further away from, passenger compartment 550 than interior trim 106. The bolster 200 may include plastic, such as polypropylene. However, bolster 200 may include other plastics and/or materials other than plastic. The bolster 200 may include material having a thickness greater than about one millimeter, such as between about two to three millimeters thick. In still other embodiments, bolster 200 may include material that is more than about three millimeters thick.

The material composition and thickness (among other dimensions) of bolster 200 may combine to enable various operational benefits. The described materials and thickness may enable bolster 200 to be restorable to its compressed condition after deployment, as discussed above. Moreover, in one or more embodiments, the weight of the bolster 200 impacting a passenger may be substantially greater than comparable materials employed in existing systems, thereby providing an impact with a passenger having different characteristics than those experienced with existing air bags.

The increased material density of the bolster and the greater weight of the bolster 200 portion impacting the passenger, in relation to existing air bags, may provide more leeway in adjusting the expansion pressure used to expand bolster 200 to optimize one or more operating parameters of passive restraint system 150. These operating parameters may include: a) an impact force of the bolster 200 against the vehicle occupant 600; b) a time period by which the expansion of bolster 200 lags the occurrence of an event triggering the activation of passive restraint system 150; and/or c) a time period by which the expansion of bolster 200 leads or lags the activation of at least one other passive restraint system. The operation of bolster 200 enabled by the above discussed structural characteristics is discussed further in connection with FIG. 4.

FIG. 4 is an elevational view of the bolster 200 of FIG. 1 extending into a passenger compartment 550 of the vehicle interior 500, in accordance with one or more embodiments of the present invention. FIG. 4 shows a vehicle occupant 600, who may have a hip or pelvic section 602 facing bolster 200, sitting in passenger compartment 550 of vehicle interior 500.

In a collision, rollover, or other triggering event, a control system (not shown) may activate passive restraint system 150, which may cause bolster 200 to expand, or inflate, such that inner surface 212 of bolster 200 may move toward passenger compartment 550 of vehicle interior 500. The inner surface 212 of layer 202 of bolster 200 may ultimately contact pelvic portion 602 of vehicle occupant 602 which may cause the pelvic portion 602 of occupant 600 to move in the same direction that inner surface 212 of bolster 200 is advancing in. Thus, in the view of FIG. 4, the pelvic portion 602 of vehicle occupant 602 may be rapidly moved to the right upon experiencing impact with inner surface 212 of bolster 200.

The material composition and/or thickness of inner layer 202 of bolster 200 may be such as to have an amount of momentum that contributes significantly to the level of impact force between inner surface 212 and pelvic portion 602 of occupant 600. Accordingly, in such embodiments, the impact force may not be as dependent upon the inflation pressure used to expand bolster 200 as are existing air bag devices. Accordingly, the inflation pressure used to expand bolster 200 may be less than that used in conventional air bags. Specifically, while inflation pressures above 100 Kilopascals (Kpa) are commonly used for conventional air bags, inflation pressures below about 100 Kpa may effectively employed for bolster 200. Moreover, in one or more embodiments, bolster 200 may be expanded employing an inflation pressure between about 80 and 90 Kpa.

The structural characteristics of bolster 200 and the inflation pressure employed in inflator 300 may combine to enable deployment of bolster 200 to be completed less than 25 milliseconds after the occurrence of a triggering event leading to activation of passive restraint system 150. Completion of the bolster 200 deployment within the stated period preferably provides sufficient inflation to the bolster 200, which is quick enough to prevent occupant 600 from experiencing impact with surfaces of vehicle door 100 that are likely to lead to injury. Moreover, the above-described time frame conforms to safety goals established by pertinent industry standards.

The upper portion of vehicle occupant 600 may lean toward the left, in the view of FIG. 4, after experiencing impact force from inner surface 212 of bolster 200. This leaning of occupant 600 may result from the pelvic portion 602 being forced to the right by bolster 200 prior to any comparable force being applied to the upper portion of vehicle occupant 600. This effect may be desirable in actual collisions, as vehicle safety testing tends to show that an optimal sequence of events, where plural passive restraint systems are deployed, may entail effecting impact between pelvic level bolster 200 and the pelvic portion 602 of vehicle occupant 600 about 8 to 10 milliseconds before effecting a similar impact between a thoracic level bolster (or other passive restraint system) and a thoracic portion (not shown) of vehicle occupant 600.

The ability to use lower inflation pressures while still achieving sufficient impact force of bolster 200 with vehicle occupant 600 is beneficial in fine tuning the power and timing of bolster 200 and/or one or more additional bolsters to implement the above-stated goal of an 8-10 millisecond gap between the pelvic and thoracic level impacts.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A passive restraint system for a vehicle, comprising:
a bolster having a first surface fixed with respect to a structural component of the vehicle and a second surface forming a portion of interior trim of the vehicle; and
an inflator for expanding the bolster and moving an inner surface of the bolster toward a passenger compartment of the vehicle, upon activation of the passive restraint system.

2. The passive restraint system of claim 1 wherein the passive restraint system is reusable after the activation.

3. The passive restraint system of claim 1 wherein the bolster includes plastic.

4. The passive restraint system of claim 1 wherein the bolster includes polypropylene.

5. The passive restraint system of claim 1 wherein material of the bolster has a thickness of about 2 to 3 millimeters.

6. The passive restraint system of claim 1 wherein the inflator is operable to expand the bolster employing a pressure less than about 100 Kilopascals (Kpa).

7. The passive restraint system of claim 1 wherein the inflator is operable to expand the bolster employing a pressure between about 80 Kpa and about 90 Kpa.

8. The passive restraint system of claim 1 wherein the inflator comprises a pyrotechnic. of an event triggering the activation of the passive restraint system.

16. The method of claim 14 further comprising setting an operating pressure of the inflator to adjust a period by which the expanding step leads or lags an activation of at least one other passive restraint system.

17. The method of claim 14 further comprising setting an operating pressure of the inflator to less than about 100 Kpa.

18. The method of claim 14 further comprising setting an operating pressure of the inflator to between about 80 and 90 Kpa.

19. The method of claim 13 further comprising re-setting the bolster after the expansion such that the passive restraint may be available for a subsequent activation.
